(19) United States
(12) Patent Application Publication
(10) Pub. No.: US 2026/0194674 A1
(43) Pub. Date: Jul. 9, 2026

(54) THREE-DIMENSIONAL REVERSE-TIME EXTRAPOLATION METHOD FOR SEISMIC WAVES AND HIGH-RESOLUTION TUNNEL SEISMIC ADVANCE PREDICTION METHOD

(71) Applicant: Chongqing Jiaotong University, Chongqing (CN)

(72) Inventors: Yuanming LAI, Chongqing (CN); Xinglin LU, Chongqing (CN); Yuanfu ZHOU, Chongqing (CN); Fenglei HAN, Chongqing (CN); Zihan ZHOU, Chongqing (CN); Shiyang LIU, Chongqing (CN)

(73) Assignee: Chongqing Jiaotong University, Chongqing (CN)

(21) Appl. No.: 19/432,911

(22) Filed: Dec. 24, 2025

(30) Foreign Application Priority Data
Jan. 9, 2025 (CN) 202510035807.7

(51) Int. Cl. G01V 1/30; E21D 9/00; G01V 1/34

(52) U.S. Cl. CPC G01V 1/303; E21D 9/003; G01V 1/301; G01V 1/345; G01V 2210/21

(57) ABSTRACT

A three-dimensional reverse-time extrapolation method for seismic waves includes the following steps: picking first-arrival traveltime information of seismic data excited and received by a tunnel wall, and calculating a P-wave velocity and an S-wave velocity of a surrounding rock based on a spacing between shot points; performing three-dimensional reverse-time extrapolation from maximum time to minimum time by using the resulting P-wave velocity and the S-wave velocity as a velocity model, and deploying a virtual geophone on a tunnel face during the calculation to receive a wavefield in the three-dimensional reverse-time extrapolation; and performing autocorrelation imaging on the wavefield after the three-dimensional reverse-time extrapolation, and further converting a seismic wavefield excited by a tunnel wall and received by the tunnel face into a seismic wavefield excited and received by the tunnel face.

### CROSS-REFERENCE TO RELATED APPLICATIONS

This application claims priority to Chinese Patent Application No. 202510035807.7, filed on Jan. 9, 2025, the content of which is incorporated herein by reference in its entirety.

### TECHNICAL FIELD

The present disclosure relates to the technical field of tunnel seismic detection and engineering survey, and in particular to a three-dimensional reverse-time extrapolation method for seismic waves and a high-resolution tunnel seismic advance prediction method.

### BACKGROUND

Tunnel seismic advance prediction methods can effectively predict unfavorable geological bodies, such as fault fracture zones, karst caves, ahead of a tunnel face, thereby reducing excavation risks. Existing tunnel seismic advance prediction methods mainly include 2-D tunnel seismic prediction (TSP), integrated seismic imaging system, horizontal seismic profiling (HSP), sonic soft ground probing, tunnel seismic tomography, tunnel seismic—while drilling method, and true reflection tomography (3D TRT).

The above methods primarily involve exciting and receiving seismic wave signals along a tunnel wall. This is primarily because deploying geophones on the tunnel face is extremely difficult due to risks such as collapses and rockfalls of the support structures. However, seismic signals recorded on the tunnel wall are heavily affected by surface wave interference due to the impact of excavation damage zone. High-energy surface waves mask the reflected waves, resulting in a significant reduction of the signal-to-noise ratio (SNR) of the reflected wave data.

Current methods for processing seismic wave signals received by the tunnel wall generally consist of three modules: preprocessing, data imaging, and geological interpretation. The preprocessing module includes data editing, spectrum analysis, band-pass filtering, automatic gain control, inverse-Q filtering, predictive deconvolution, and F-K filtering. The imaging module includes full-waveform inversion (FWI) and two-dimensional/three-dimensional migration imaging. The geological interpretation module includes data imaging interpretation and geological data analysis. Since the strong-energy surface waves in the raw seismic data received by the tunnel wall can mask the reflected wave data, existing data processing methods cannot extract accurate reflected wave data, resulting in poor accuracy in geological prediction. Therefore, current methods for processing seismic wave signals received by tunnel wall still have room for improvement.

Considering safety and construction efficiency, previous tunnel seismic advance prediction methods failed to deploy geophones on the tunnel face to receive seismic wave signals. Subsequent data processing methods are also based on seismic wave signals received by the tunnel wall. In combination with the principles of seismic wave extrapolation at the tunnel excavation site and within the tunnel space, the present disclosure provides a high-resolution tunnel seismic prediction method based on three-dimensional reverse-time extrapolation, aiming to suppress strong surface-wave interference in the seismic data received by the tunnel wall, improving the resolution of reflected waves and ultimately improving the accuracy of tunnel seismic advance prediction.

### SUMMARY

In view of at least one defect in the prior art, the present disclosure provides a three-dimensional reverse-time extrapolation method for seismic waves, aiming to suppress strong surface-wave interference in the seismic data received by the tunnel wall, improving the resolution of reflected waves and ultimately improving the accuracy of tunnel seismic advance prediction.

In order to achieve the above objective, the present disclosure adopts the following technical solutions.

A three-dimensional reverse-time extrapolation method for seismic waves includes the following steps:
step 1: picking first-arrival traveltime information of seismic data excited and received by a tunnel wall, and calculating a P-wave velocity (Vp) and an S-wave velocity (Vs) of a surrounding rock based on a spacing between shot points;
step 2: performing three-dimensional reverse-time extrapolation from maximum time to minimum time by using the resulting P-wave velocity (Vp) and the S-wave velocity (Vs) as a velocity model, converting the wavefield received by a tunnel wall into a wavefield by a virtual geophone at a tunnel face, and receiving the wavefield obtained from the three-dimensional reverse-time extrapolation during the calculation; and
step 3: performing autocorrelation imaging on the wavefield after the three-dimensional reverse-time extrapolation, and further converting a seismic wavefield excited by a tunnel wall and received by the tunnel face into a seismic wavefield excited by the tunnel face and received by the tunnel face.

Specific derivation formulas for the three-dimensional reverse-time extrapolation in the step 2 are as follows:
formulas for calculating decoupled first-order partial differential equations in a three-dimensional elastic wave equation are expressed as follows:

$$\frac{\partial {v}_{x}}{\partial t} = \frac{1}{ρ} ( \frac{\partial {τ}_{x x}}{\partial x} + \frac{\partial {τ}_{x y}}{\partial y} + \frac{\partial {τ}_{xz}}{\partial z} + {f}_{x} ) ; \qquad ( 1 )$$

$$\frac{\partial {v}_{y}}{\partial t} = \frac{1}{ρ} ( \frac{\partial {τ}_{xy}}{\partial x} + \frac{\partial {τ}_{yy}}{\partial y} + \frac{\partial {τ}_{yz}}{\partial z} + {f}_{y} ) ; \qquad ( 2 )$$

$$\frac{\partial {v}_{z}}{\partial t} = \frac{1}{ρ} ( \frac{\partial {τ}_{x z}}{\partial x} + \frac{\partial {τ}_{yz}}{\partial y} + \frac{\partial {τ}_{zz}}{\partial z} + {f}_{z} ) ; \qquad ( 3 )$$

$$\frac{\partial {τ}_{x x}}{\partial t} = ( λ + 2 μ ) \frac{\partial {v}_{x}}{\partial x} + λ ( \frac{\partial {v}_{y}}{\partial y} + \frac{\partial {v}_{z}}{\partial z} ) ; \qquad ( 4 )$$

$$\frac{\partial {τ}_{yy}}{\partial t} = ( λ + 2 μ ) \frac{\partial {v}_{y}}{\partial y} + λ ( \frac{\partial {v}_{x}}{\partial x} + \frac{\partial {v}_{z}}{\partial z} ) ; \qquad ( 5 )$$

$$\frac{\partial {τ}_{zz}}{\partial t} = ( λ + 2 μ ) \frac{\partial {v}_{z}}{\partial z} + λ ( \frac{\partial {v}_{x}}{\partial x} + \frac{\partial {v}_{y}}{\partial y} ) ; \qquad ( 6 )$$

$$\frac{\partial {τ}_{xy}}{\partial t} = μ ( \frac{\partial {v}_{x}}{\partial y} + \frac{\partial {v}_{y}}{\partial x} ) ; \qquad ( 7 )$$

$$\frac{\partial {τ}_{x z}}{\partial t} = μ ( \frac{\partial {v}_{x}}{\partial z} + \frac{\partial {v}_{z}}{\partial x} ) ; \qquad ( 8 )$$

$$\frac{\partial {τ}_{yz}}{\partial t} = μ ( \frac{\partial {v}_{y}}{\partial z} + \frac{\partial {v}_{z}}{\partial y} ) ; \qquad ( 9 )$$

The differential equations (1)-(9) are discretized to obtain finite difference formulas for the three-dimensional time-reverse extrapolation:

$${v}_{x i + 1 / 2 , j , k}^{n - 1 / 2} = {v}_{xi + 1 / 2 , j , k}^{n - 1 / 2} - \frac{Δ t}{Δ x} ( {τ}_{xx + 1 / 2 , j , k}^{n} - {τ}_{xx i - 1 / 2 , j , k}^{n} ) - \frac{Δ t}{Δ y} ( {τ}_{xy i , j + 1 / 2 , j , k}^{n} - {τ}_{xy i , j - 1 / 2 , k}^{n} ) - \frac{Δ t}{Δ z} ( {τ}_{xz i , j , k + 1 / 2}^{n} - {τ}_{xz i , j , k - 1 / 2}^{n} ) + {f}_{x} ; \qquad ( 10 )$$

$${v}_{yi , j + 1 / 2 , k}^{n - 1 / 2} = {v}_{yi , j + 1 / 2 , k}^{n - 1 / 2} - \frac{Δ t}{Δ x} ( {τ}_{xy i + 1 / 2 , j , k}^{n} - {τ}_{xy i - 1 / 2 , j , k}^{n} ) - \frac{Δ t}{Δ y} ( {τ}_{yy i , j + 1 / 2 , k}^{n} - {τ}_{yy i , j - 1 / 2 , k}^{n} ) - \frac{Δ t}{Δ z} ( {τ}_{yz i , j , k + 1 / 2}^{n} - {τ}_{yz i , j , k - 1 / 2}^{n} ) + {f}_{y} ; \qquad ( 11 )$$

$${v}_{zi , j + 1 / 2}^{n - 1 / 2} = {v}_{zi , j , k + 1 / 2}^{n + 1 / 2} - \frac{Δ t}{Δ x} ( {τ}_{xz i + 1 / 2 , j , k}^{n} - {τ}_{xz i - 1 / 2 , j , k}^{n} ) - \frac{Δ t}{Δ y} ( {τ}_{yz i , j + 1 / 2 , k}^{n} - {τ}_{yz i , j - 1 / 2 , k}^{n} ) - \frac{Δ t}{Δ z} ( {τ}_{zz i , j , k + 1 / 2}^{n} - {τ}_{zz i , j , k - 1 / 2}^{n} ) + {f}_{z} ; \qquad ( 12 )$$

For velocity components:

$${τ}_{xxi , j , k}^{n} = {τ}_{xxi , j , k}^{n + 1} - \frac{Δ t}{Δ x} ( λ + 2 μ ) ( {v}_{x i + 1 / 2 , j , k}^{n + 1 / 2} - {v}_{x i + 1 / 2 , j , k}^{n + 1 / 2} ) - \frac{Δ t}{Δ y} λ ( {v}_{y i , j + 1 / 2 , k}^{n + 1 / 2} - {v}_{y i , j + 1 / 2 , k}^{n + 1 / 2} ) - \frac{Δ t}{Δ y} λ ( {v}_{z i , j , k + 1 / 2}^{n + 1 / 2} - {v}_{z i , j , k - 1 / 2}^{n + 1 / 2} ) ; \qquad ( 13 )$$

$${τ}_{yy i , j , k}^{n} = {τ}_{yy i , j , k}^{n + 1} - \frac{Δ t}{Δ y} ( λ + 2 μ ) ( {v}_{y i , j + 1 / 2 , k}^{n + 1 / 2} - {v}_{y i , j - 1 / 2 , k}^{n + 1 / 2} ) - \frac{Δ t}{Δ x} λ ( {v}_{x i + 1 / 2 , j , k}^{n + 1 / 2} - {v}_{x i - 1 / 2 , j , k}^{n + 1 / 2} ) - \frac{Δ t}{Δ z} λ ( {v}_{z i , j , k + 1 / 2}^{n + 1 / 2} - {v}_{z i , j , k - 1 / 2}^{n + 1 / 2} ) ; \qquad ( 14 )$$

$${τ}_{zz i , j , k}^{n} = {τ}_{zz i , j , k}^{n + 1} - \frac{Δ t}{Δ y} ( λ + 2 μ ) ( {v}_{z i , j , k + 1 / 2}^{n + 1 / 2} - {v}_{z i , j , k - 1 / 2}^{n + 1 / 2} ) - \frac{Δ t}{Δ x} λ ( {v}_{x i + 1 / 2 , j , k}^{n + 1 / 2} - {v}_{x i - 1 / 2 , j , k}^{n + 1 / 2} ) - \frac{Δ t}{Δ y} λ ( {v}_{y i , j , k + 1 / 2 , k}^{n + 1 / 2} - {v}_{y i , j - 1 / 2 , k}^{n + 1 / 2} ) ; \qquad ( 15 )$$

$${τ}_{xyi + 1 / 2 , j + 1 / 2 , k}^{n} = {τ}_{xyi + 1 / 2 , j + 1 / 2 , k}^{n + 1} - \frac{Δ t}{Δ y} ( {v}_{x i , j + 1 / 2 , k}^{n + 1 / 2} - {v}_{x i , j - 1 / 2 , k}^{n + 1 / 2} ) - \frac{Δ t}{Δ x} ( {v}_{y i + 1 / 2 , j , k}^{n + 1 / 2} - {v}_{y i - 1 / 2 , j , k}^{n + 1 / 2} ) ; \qquad ( 16 )$$

$${τ}_{xzi + 1 / 2 , j , k + 1 / 2}^{n} = {τ}_{xzi + 1 / 2 , j , k + 1 / 2}^{n + 1} - \frac{Δ t}{Δ z} ( {v}_{x i , j , k + 1 / 2}^{n + 1 / 2} - {v}_{x i , j , k - 1 / 2}^{n + 1 / 2} ) - \frac{Δ t}{Δ x} ( {v}_{z i + 1 / 2 , j , k}^{n + 1 / 2} - {v}_{z i - 1 / 2 , j , k}^{n + 1 / 2} ) ; \qquad ( 17 )$$

$${τ}_{yzi , j + 1 / 2 , k + 1 / 2}^{n} = {τ}_{yzi , j + 1 / 2 , k + 1 / 2}^{n + 1} - \frac{Δ t}{Δ z} ( {v}_{y i , j , k + 1 / 2}^{n + 1 / 2} - {v}_{y i , j , k - 1 / 2}^{n + 1 / 2} ) - \frac{Δ t}{Δ y} ( {v}_{z i , j + 1 / 2 , k}^{n + 1 / 2} - {v}_{z i , j - 1 / 2 , k}^{n + 1 / 2} ) ; \qquad ( 18 )$$

In the above formulas, i, j and k are subscripts in X, Y, and Z spatial directions, respectively. x, y and z denote three directional components in the X, Y, and Z spatial directions, respectively; n is a superscript of time. Δx, Δy and Δz denote the grid spacings in X, Y, and Z directions, respectively, with a sampling interval of Δt, X, Y, and Z denote three directions in a tunnel space, where X is a horizontal direction parallel to the tunnel face, Y is a tunnel advancing direction, and Z is a vertically downward direction parallel to the tunnel face. Formulas (1)-(18) are 2-order accurate in both space and time. Similarly, a spatial accuracy can be extended to 2 L-order, where L is an integer ranging from 1 to 6. In Formulas (1)-(18), vₓ, v_{y} and v_{z} denote velocity components in the X, Y, and Z directions, respectively. (τₓₓ, τ_{yy}, τ_{zz}, τ_{xy}, τ_{yz}, τ_{xz}) denote stress components, where τₓₓ denotes a stress component in an X direction, τ_{yy} denotes a stress component in a Y direction, τ_{zz} denotes a stress component in a Z direction, τ_{xy} denotes a stress component of a resultant force in X and Y direction, τ_{yz} denotes a stress component of a resultant force in Y and Z direction, and τ_{xz} denotes a stress component of a resultant force in X and Z direction. (fₓ, f_{y}, f_{z}) denote a body-force source component in the X, Y, and Z directions, respectively, and denote three-component seismic data received by the tunnel wall during the three-dimensional reverse-time extrapolation; ρ denotes a density of media; λ and μ denote a first parameter and a second parameter of Lamé constants, respectively, and their relationships with the P-wave velocity Vp and the S-wave velocity Vs are as follows:

$$λ = ρ ( {Vp}^{2} - 2 {Vs}^{2} ) ; \qquad ( 19 )$$

$$μ = {ρVs}^{2} ; \qquad ( 20 )$$

specifically, a wavefield from maximum time to minimum time is calculated through the reverse-time extrapolation by using the calculation formulas given in Formulas (9)-(18), and the virtual geophone deployed on the tunnel face is configured to receive the wavefield in the reverse-time extrapolation during the calculation.

Band-pass filtering, automatic gain control, predictive deconvolution, full-waveform inversion, reverse-time migration processing steps are then performed.

The three-dimensional reverse-time extrapolation method for seismic waves further includes a step 4 as follows: performing band-pass filtering, automatic gain control, predictive deconvolution, full-waveform inversion, reverse-time migration data processing based on the results obtained in the step 3.

A high-resolution tunnel seismic advance prediction method is provided, and the method includes the three-dimensional reverse-time extrapolation method for seismic waves:
specifically, a virtual geophone is disposed on a tunnel face. By applying three-dimensional reverse-time extrapolation, an observation system for tunnel wall excitation-tunnel wall reception is calculated, a wavefield received by a tunnel wall is recursively extrapolated to a location of the virtual geophone on the tunnel face, and an observation system for tunnel wall excitation-tunnel wall reception is finally converted.

The specific steps for data processing are as follows:
step A: data preprocessing, including data editing, band-pass filtering, F-K filtering and automatic gain control;
step B: data imaging, including three-dimensional reverse-time extrapolation, predictive deconvolution, full-waveform inversion and two-dimensional/three-dimensional migration imaging; where the three-dimensional reverse-time extrapolation adopts the three-dimensional reverse-time extrapolation method for seismic waves to process the data; and
step C: geological interpretation: geological interpretation: extracting unfavorable geological bodies, determining surrounding-rock classification, and providing support recommendations based on results of the full-waveform inversion and reverse-time migration imaging.

The present disclosure provides a three-dimensional reverse-time extrapolation method for seismic waves and a high-resolution tunnel seismic advance prediction method, aiming to suppress strong surface-wave interference in the seismic data received by the tunnel wall, improving the resolution of reflected waves and ultimately improving the accuracy of tunnel seismic advance prediction.

### BRIEF DESCRIPTION OF THE DRAWINGS

FIG. 1 is a schematic diagram of a principle for three-dimensional reverse-time extrapolation in a tunnel.

FIG. 2 is a data processing flowchart of a high-resolution tunnel seismic advance prediction method based on three-dimensional reverse-time extrapolation.

FIG. 3 is a three-dimensional tunnel model containing a karst cave and a weak interlayer in a tunnel.

FIGS. 4A-4C illustrate three-component seismic records excited by a tunnel wall and received by a geophone G1 at a tunnel wall, where FIG. 4A X component; FIG. 4B Y component; and FIG. 4C Z component.

FIGS. 5A-5C illustrate three-component seismic records excited by a tunnel wall and received by a geophone G2 at a tunnel wall, where FIG. 5A X component; FIG. 5B Y component; and FIG. 5C Z component.

FIGS. 6A-6C illustrate three-component seismic records excited by a tunnel wall and received by a tunnel face, where FIG. 6A X component; FIG. 6B Y component; and FIG. 6C Z component.

FIGS. 7A-7C illustrate three-component seismic records excited by a tunnel wall and received by a tunnel face by applying three-dimensional reverse-time extrapolation, where FIG. 7A X component; FIG. 7B Y component; and FIG. 7C Z component.

FIGS. 8A-8C illustrate three-component autocorrelation seismic records excited by a tunnel wall and received by a tunnel face, where FIG. 8A X component; FIG. 8B Y component; and FIG. 8C Z component.

FIGS. 9A-9C illustrate three-component autocorrelation seismic records excited by a tunnel wall and received by a tunnel face by applying three-dimensional reverse-time extrapolation, where FIG. 9A X component; FIG. 9B Y component; and FIG. 9C Z component.

FIG. 10 is a flowchart of the three-dimensional reverse-time extrapolation method for seismic waves.

FIG. 11 is a flowchart of the data processing steps for the high-resolution tunnel seismic advance prediction method.

### DETAILED DESCRIPTIONS OF THE EMBODIMENTS

The present disclosure will be further described below with reference to the accompanying drawings and the particular embodiments.

The present disclosure provides a three-dimensional reverse-time extrapolation method for seismic waves and a high-resolution tunnel seismic advance prediction method, aiming to suppress strong surface-wave interference in the seismic data received by the tunnel wall, improving the resolution of reflected waves and ultimately improving the accuracy of tunnel seismic advance prediction.

The present disclosure adopts the following technical solutions.

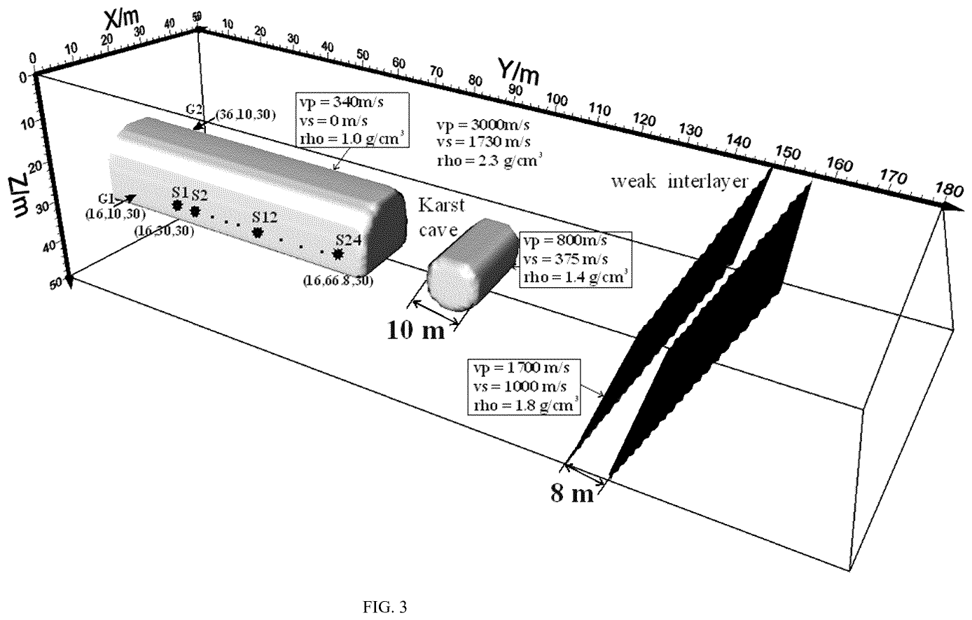

1. A three-dimensional reverse-time extrapolation method for seismic waves and a high-resolution tunnel seismic advance prediction method are provided. Taking a conventional tunnel seismic advance prediction acquisition system as an example, as shown in FIGS. 1 and 3, a specific data acquisition method involves firing 24 shots and deploying 2 geophones along a tunnel wall to receive seismic wave signals. A specific process for three-dimensional reverse-time extrapolation procedure for tunnel seismic analysis is as follows: virtual geophones are set up at a tunnel face to receive seismic wave signals, the seismic wave signals received by the tunnel wall are extrapolated to a location of the tunnel face using three-dimensional reverse-time extrapolation calculation, the location received the seismic wave signals is changed, and an observation system for tunnel wall excitation-tunnel wall reception is converted into an observation system for tunnel wall excitation-tunnel face reception. Specific derivation formulas for the three-dimensional reverse-time extrapolation are as follows:
formulas for calculating decoupled first-order partial differential equations in a three-dimensional elastic wave equation are expressed as follows:

$$\frac{\partial {v}_{x}}{\partial t} = \frac{1}{ρ} ( \frac{\partial {τ}_{xx}}{\partial x} + \frac{\partial {τ}_{xy}}{\partial y} + \frac{\partial {τ}_{xz}}{\partial z} + {f}_{x} ) ; \qquad ( 1 )$$

$$\frac{\partial {v}_{y}}{\partial t} = \frac{1}{ρ} ( \frac{\partial {τ}_{xy}}{\partial x} + \frac{\partial {τ}_{yy}}{\partial y} + \frac{\partial {τ}_{yz}}{\partial z} + {f}_{y} ) ; \qquad ( 2 )$$

$$\frac{\partial {v}_{z}}{\partial t} = \frac{1}{ρ} ( \frac{\partial {τ}_{xz}}{\partial x} + \frac{\partial {τ}_{yz}}{\partial y} + \frac{\partial {τ}_{zz}}{\partial z} + {f}_{z} ) ; \qquad ( 3 )$$

$$\frac{\partial {τ}_{xx}}{\partial t} = ( λ + 2 μ ) \frac{\partial {v}_{x}}{\partial x} + λ ( \frac{\partial {v}_{y}}{\partial y} + \frac{\partial {v}_{z}}{\partial z} ) ; \qquad ( 4 )$$

$$\frac{\partial {τ}_{yy}}{\partial t} = ( λ + 2 μ ) \frac{\partial {v}_{y}}{\partial y} + λ ( \frac{\partial {v}_{x}}{\partial x} + \frac{\partial {v}_{z}}{\partial z} ) ; \qquad ( 5 )$$

$$\frac{\partial {τ}_{zz}}{\partial t} = ( λ + 2 μ ) \frac{\partial {v}_{z}}{\partial z} + λ ( \frac{\partial {v}_{x}}{\partial y} + \frac{\partial {v}_{y}}{\partial y} ) ; \qquad ( 6 )$$

$$\frac{\partial {τ}_{xy}}{\partial t} = μ ( \frac{\partial {v}_{x}}{\partial y} + \frac{\partial {v}_{y}}{\partial x} ) ; \qquad ( 7 )$$

$$\frac{\partial {τ}_{xz}}{\partial t} = μ ( \frac{\partial {v}_{x}}{\partial z} + \frac{\partial {v}_{z}}{\partial x} ) ; \qquad ( 8 )$$

Formulas (1)-(9) represent the three-dimensional elastic wave equations used for numerical simulation. During forward modeling, a wavefield at time T+1 is extrapolated by using the wavefield at time T. Unlike forward modeling, the three-dimensional reverse-time extrapolation uses the wavefield at time T−1 to calculate the wavefield at time T in reverse time. Therefore, the difference formulas for time-reverse extrapolation are significantly different from those in the forward modeling processing. The differential equations (1)-(9) are discretized to obtain finite difference formulas for the three-dimensional time-reverse extrapolation:

$${v}_{x i + 1 / 2 , j , k}^{n - 1 / 2} = {v}_{x i + 1 / 2 , j , k}^{n + 1 / 2} - \frac{Δ t}{Δ x} ( {τ}_{xx i + 1 / 2 , j , k}^{n} - {τ}_{xx i + 1 / 2 , j , k}^{n} ) - \frac{Δ t}{Δ y} ( {τ}_{xy i + 1 / 2 , k}^{n} - {τ}_{xy i , j + 1 / 2 , k}^{n} ) - \frac{Δ t}{Δ z} ( {τ}_{xz i , j , k + 1 / 2}^{n} - {τ}_{xz i , j , k - 1 / 2}^{n} ) + {f}_{x} ; \qquad ( 10 )$$

$${v}_{yi j + 1 / 2 , k}^{n - 1 / 2} = {v}_{yi , j + 1 / 2 , k}^{n + 1 / 2} - \frac{Δ t}{Δ x} ( {τ}_{xy i + 1 / 2 , j , k}^{n} - {τ}_{xy i + 1 / 2 , j , k}^{n} ) - \frac{Δ t}{Δ y} ( {τ}_{yy i , j + 1 / 2 , k}^{n} - {τ}_{yy i , j + 1 / 2 , k}^{n} ) - \frac{Δ t}{Δ z} ( {τ}_{yz i , j , k + 1 / 2}^{n} - {τ}_{yz i , j , k - 1 / 2}^{n} ) + {f}_{y} ; \qquad ( 11 )$$

$${v}_{zi , j , k + 1 / 2}^{n - 1 / 2} = {v}_{zi , j , k + 1 / 2}^{n + 1 / 2} - \frac{Δ t}{Δ x} ( {τ}_{xz i + 1 / 2 , j , k}^{n} - {τ}_{xz i - 1 / 2 , j , k}^{n} ) - \frac{Δ t}{Δ y} ( {τ}_{yz i , j + 1 / 2 , k}^{n} - {τ}_{yz i , j + 1 / 2 , k}^{n} ) - \frac{Δ t}{Δ z} ( {τ}_{zz i , j , k + 1 / 2}^{n} - {τ}_{zz i , j , k - 1 / 2}^{n} ) + {f}_{z} ; \qquad ( 12 )$$

For velocity components:

$${τ}_{xxi , j , k}^{n} = {τ}_{xxi , j , k}^{n + 1} - \frac{Δ t}{Δ x} ( λ + 2 μ ) ( {v}_{x i + 1 / 2 , j , k}^{n + 1 / 2} - {v}_{x i - 1 / 2 , j , k}^{n + 1 / 2} ) - \frac{Δ t}{Δ y} λ ( {v}_{y i , j + 1 / 2 , k}^{n + 1 / 2} - {v}_{y i , j - 1 / 2 , k}^{n + 1 / 2} ) - \frac{Δ t}{Δ y} λ ( {v}_{z i , j , k + 1 / 2}^{n + 1 / 2} - {v}_{z i , j , k - 1 / 2}^{n + 1 / 2} ) ; \qquad ( 13 )$$

$${τ}_{yy i , j , k}^{n} = {τ}_{yy i , j , k}^{n + 1} - \frac{Δ t}{Δ y} ( λ + 2 μ ) ( {v}_{y i , j + 1 / 2 , k}^{n + 1 / 2} - {v}_{y i , j - 1 / 2 , k}^{n + 1 / 2} ) - \frac{Δ t}{Δ x} λ ( {v}_{x i + 1 / 2 , j , k}^{n + 1 / 2} - {v}_{x i - 1 / 2 , j , k}^{n + 1 / 2} ) - \frac{Δ t}{Δ z} λ ( {v}_{z i , j , k + 1 / 2}^{n + 1 / 2} - {v}_{z i , j , k - 1 / 2}^{n + 1 / 2} ) ; \qquad ( 14 )$$

$${τ}_{zz i , j , k}^{n} = {τ}_{zz i , j , k}^{n + 1} - \frac{Δ t}{Δ z} ( λ + 2 μ ) ( {v}_{y i , j + 1 / 2 , k}^{n + 1 / 2} - {v}_{y i , j - 1 / 2 , k}^{n + 1 / 2} ) - \frac{Δ t}{Δ x} λ ( {v}_{x i + 1 / 2 , j , k}^{n + 1 / 2} - {v}_{x i - 1 / 2 , j , k}^{n + 1 / 2} ) - \frac{Δ t}{Δ z} λ ( {v}_{z i , j , k + 1 / 2}^{n + 1 / 2} - {v}_{z i , j , k - 1 / 2}^{n + 1 / 2} ) ; \qquad ( 15 )$$

$${τ}_{xyi + 1 / 2 , j + 1 / 2 , k}^{n} = {τ}_{xyi + 1 / 2 , j + 1 / 2 , k}^{n + 1} - \frac{Δ t}{Δ y} ( {v}_{x i , j + 1 / 2 , k}^{n + 1 / 2} - {v}_{x i , j - 1 / 2 , k}^{n + 1 / 2} ) - \frac{Δ t}{Δ x} ( {v}_{y i + 1 / 2 , j , k}^{n + 1 / 2} - {v}_{y i - 1 / 2 , j , k}^{n + 1 / 2} ) ; \qquad ( 16 )$$

$${τ}_{xzi + 1 / 2 , j , k + 1 / 2}^{n} = {τ}_{xzi + 1 / 2 , j , k + 1 / 2}^{n + 1} - \frac{Δ t}{Δ z} ( {v}_{x i , j , k + 1 / 2}^{n + 1 / 2} - {v}_{x i , j , k - 1 / 2}^{n + 1 / 2} ) - \frac{Δ t}{Δ x} ( {v}_{z i + 1 / 2 , j , k}^{n + 1 / 2} - {v}_{z i - 1 / 2 , j , k}^{n + 1 / 2} ) ; \qquad ( 17 )$$

$${τ}_{yzi , j + 1 / 2 , j , k + 1 / 2}^{n} = {τ}_{yzi , j + 1 / 2 , k + 1 / 2}^{n + 1} - \frac{Δ t}{Δ z} ( {v}_{y i , j , k + 1 / 2}^{n + 1 / 2} - {v}_{y i , j , k - 1 / 2}^{n + 1 / 2} ) - \frac{Δ t}{Δ y} ( {v}_{z i , j + 1 / 2 , k}^{n + 1 / 2} - {v}_{z i , j - 1 / 2 , k}^{n + 1 / 2} ) . \qquad ( 18 )$$

In the above formulas, i, j and k are subscripts in X, Y, and Z spatial directions, respectively. x, y and z denote three directional components in the X, Y, and Z spatial directions, respectively. n is a superscript of time. Δx, Δy and Δz denote the grid spacings in X, Y, and Z directions, respectively, with a sampling interval of Δt, X, Y, and Z denote three directions in a tunnel space, where X is a horizontal direction parallel to the tunnel face, Y is a tunnel advancing direction, and Z is a vertically downward direction parallel to the tunnel face.

Formulas (1)-(18) are 2-order accurate in both space and time. Similarly, a spatial accuracy can be extended to 2 L-order, where L is an integer ranging from 1 to 6. In Formulas (1)-(18), vₓ, v_{y} and v_{z} denote velocity components in the X, Y, and Z directions, respectively. (τₓₓ, τ_{yy}, τ_{zz}, τ_{xy}, τ_{yz}, τ_{xz}) denote stress components, where τₓₓ denotes a stress component in an X direction, τ_{yy} denotes a stress component in a Y direction, τ_{zz} denotes a stress component in a Z direction, τ_{xy} denotes a stress component of a resultant force in X and Y direction, τ_{yz} denotes a stress component of a resultant force in Y and Z direction, and τ_{xz} denotes a stress component of a resultant force in X and Z direction. (fₓ, f_{y}, f_{z}) denote a body-force source component in the X, Y, and Z directions, respectively, and denote seismic data of 24 three-components received by the tunnel wall during the three-dimensional reverse-time extrapolation; ρ denotes a density of media; λ and μ denote a first parameter and a second parameter of Lamé constants, respectively, and their relationships with the P-wave velocity Vp and the S-wave velocity Vs are as follows:

$$λ = ρ ( {Vp}^{2} - 2 {Vs}^{2} ) ; \qquad ( 19 )$$

$$μ = ρ {Vs}^{2} . \qquad ( 20 )$$

The present disclosure will be further described in detail below with reference to accompanying drawings.

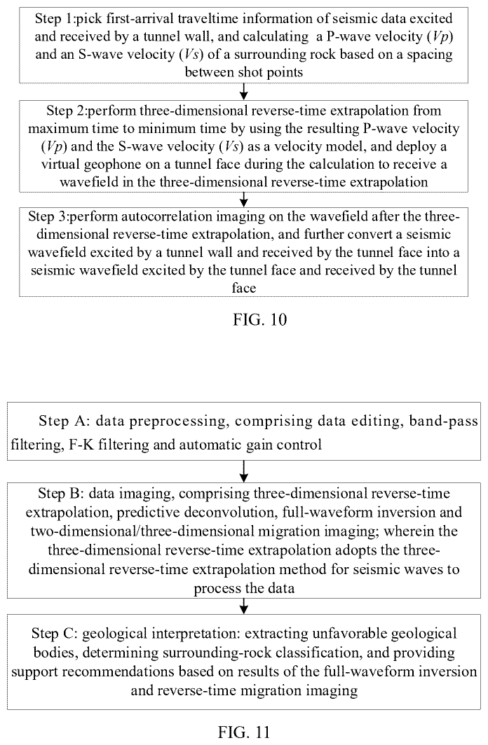

As shown in FIGS. 1-11, the present disclosure provides a three-dimensional reverse-time extrapolation method for seismic waves and a high-resolution tunnel seismic advance prediction method. As shown in FIG. 1, a virtual geophone is disposed on a tunnel face. By applying three-dimensional reverse-time extrapolation, an observation system for tunnel wall excitation-tunnel wall reception is calculated, a wavefield received by a tunnel wall is recursively extrapolated to a location of the virtual geophone on the tunnel face, and an observation system for tunnel wall excitation-tunnel wall reception is finally converted. The present disclosure has the following specific advantages.

(1) The method can implement the observation system for tunnel wall excitation-tunnel wall reception without increasing seismic acquisition costs at tunnel construction sites.

(2) Through three-dimensional reverse-time extrapolation, strong surface-wave interference in seismic data received by the tunnel wall is calculated, improving the resolution of reflected waves and ultimately improving the accuracy of tunnel seismic advance prediction.

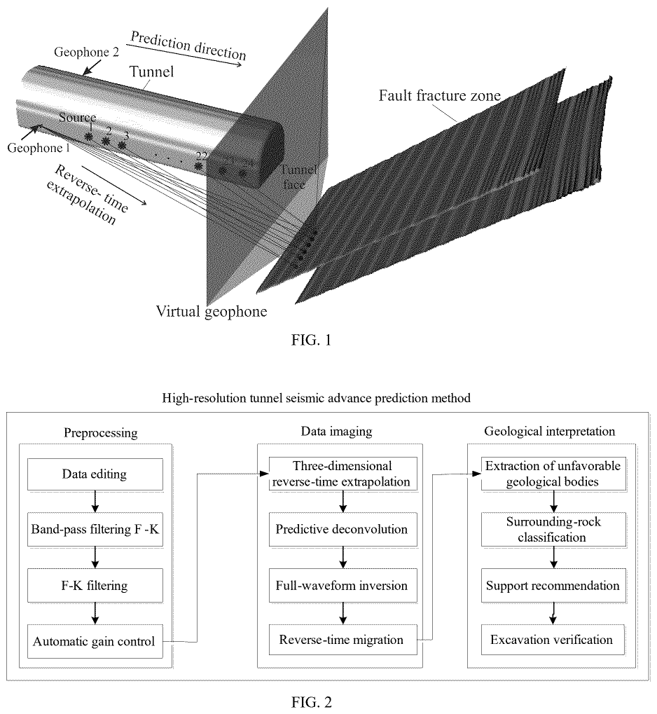

As shown in FIG. 2, the specific steps for data processing are as follows:

(1) preprocessing includes data editing, spectrum analysis, band-pass filtering, F-K filtering and automatic gain control; etc.; and

(2) data imaging includes three-dimensional reverse-time extrapolation, predictive deconvolution, full-waveform inversion and two-dimensional/three-dimensional migration imaging;
as shown in FIGS. 1, 3 and 10, the detailed steps of the three-dimensional reverse-time extrapolation are as follows:
1) picking first-arrival traveltime information of seismic data excited and received by a tunnel wall, and calculating a P-wave velocity (Vp) and an S-wave velocity (Vs) of a surrounding rock based on a spacing between shot points;
2) performing three-dimensional reverse-time extrapolation from maximum time to minimum time by using the resulting P-wave velocity (Vp) and the S-wave velocity (Vs) as a velocity model and using the calculation formulas given in Formulas (9)-(18), and deploying a virtual geophone on a tunnel face during the calculation to receive a wavefield in the three-dimensional reverse-time extrapolation;
3) performing autocorrelation imaging on the wavefield after reverse-time extrapolation, and further converting a seismic wavefield excited by a tunnel wall and received by the tunnel face into a seismic wavefield excited by the tunnel face and received by the tunnel face; and
4) performing band-pass filtering, automatic gain control, predictive deconvolution, full-waveform inversion, reverse-time migration data processing based on the results obtained in the step 3).
(3) Geological interpretation: based on results of the full-waveform inversion and reverse-time migration imaging, unfavorable geological bodies are extracted, the surrounding-rock classification is determined, support recommendations are provided, and the excavation results are continuously monitored to verify the prediction conclusions.

The present disclosure analyzes the extrapolation process and wavefield characteristics of elastic waves in a three-dimensional tunnel space, and creatively provides a three-dimensional reverse-time extrapolation method for seismic waves. The method converts the original observation system for tunnel wall excitation-tunnel wall reception into an observation system for tunnel wall excitation-tunnel face reception, suppressing the strong surface-wave interference in the seismic data received by the tunnel wall, improving the resolution of reflected waves and enhancing the resolution of reflected waves in a leading direction.

As a key step in high-resolution tunnel seismic data processing, the three-dimensional reverse-time extrapolation method for seismic waves falls within the scope of protection of the present disclosure. The method is not limited to the observation system of 24 shot points and 2 geophones described in this embodiment, and it is also applicable to the data acquired by other tunnel seismic observation systems.

### Model Experiment

### 1. Tunnel Seismic Data Acquisition

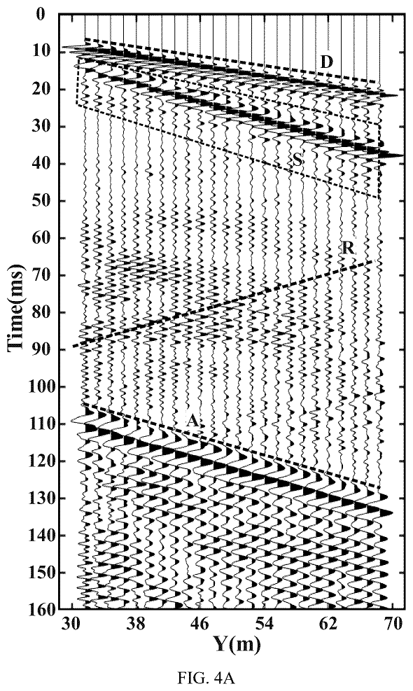

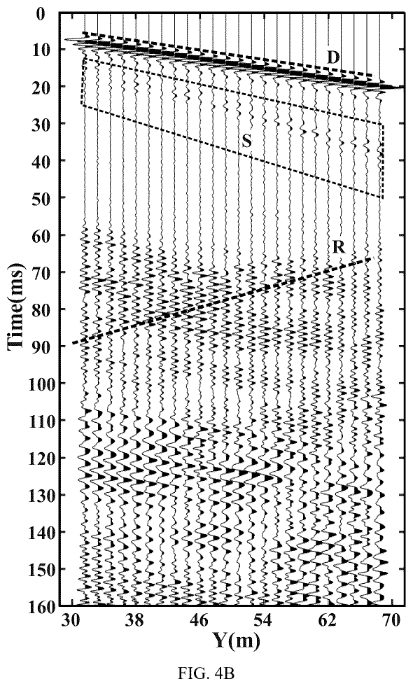

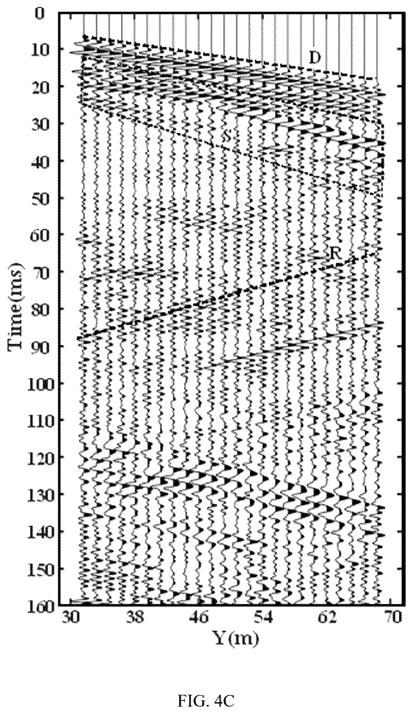

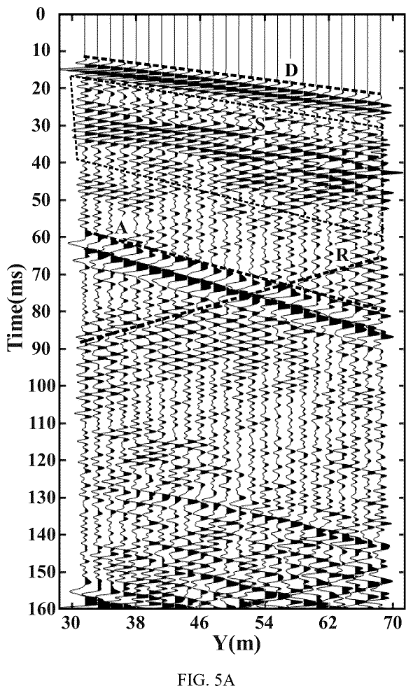

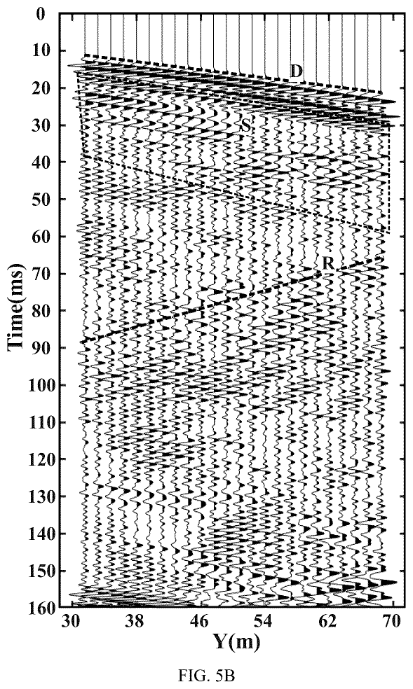

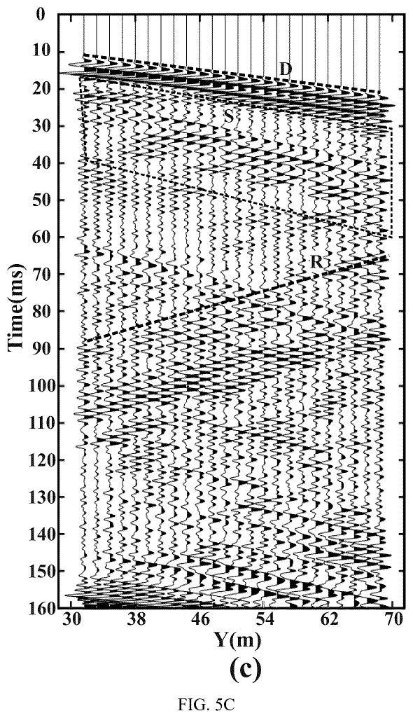

To verify the methods of the present disclosure, a three-dimensional karst cave and weak interlayer model was designed, as shown in FIG. 3. G1 and G2 are positions of two geophones, and S1, S2-S24 denote 24 shot points. A surrounding rock has a P-wave velocity of 3,000 m/s, an S-wave velocity of 1,730 m/s, and a density of 2.3 g/cm³. The tunnel space has a P-wave velocity of 340 m/s, an S-wave velocity of 0 m/s, and a density of 1.0 g/cm³. The karst cave has a diameter of 10 m, with a P-wave velocity of 800 m/s, an S-wave velocity of 375 m/s, and a density of 1.4 g/cm³. The weak interlayer has a thickness of 8 m, with a P-wave velocity of 1,700 m/s, an S-wave velocity of 1,000 m/s, and a density of 1.8 g/cm³. A data sampling interval is 40 μs, and each trace contains 4000 sampling points. Data of 24 shots were simulated, and three-component seismic wave signals were recorded at the locations of G1 and G2. The three-component seismic wave signals received by the G1 geophone are shown in FIGS. 4A-4C. The three-component seismic wave signals received by the G2 geophone are shown in FIGS. 5A-5C. Symbol D represents a direct wave, S represents a surface wave, A represents an acoustic wave, and R represents a reflected wave from ahead of the tunnel face. When the elastic wave propagates along the tunnel wall, strong surface-wave interference is generated, which degrades the resolution of the reflected wave from ahead of the tunnel face, making the reflected wave difficult to be identified and extracted, thus severely affecting the prediction accuracy of unfavorable geological bodies.

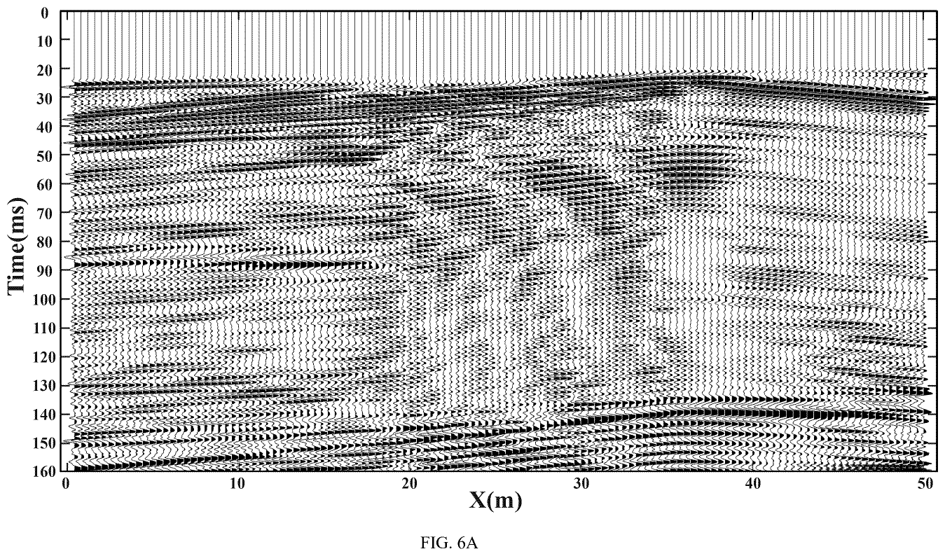

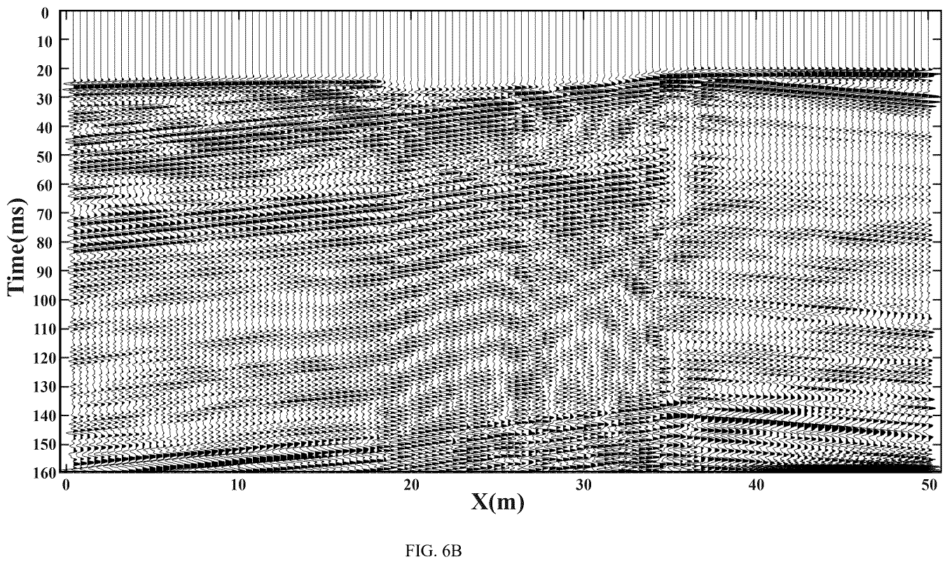

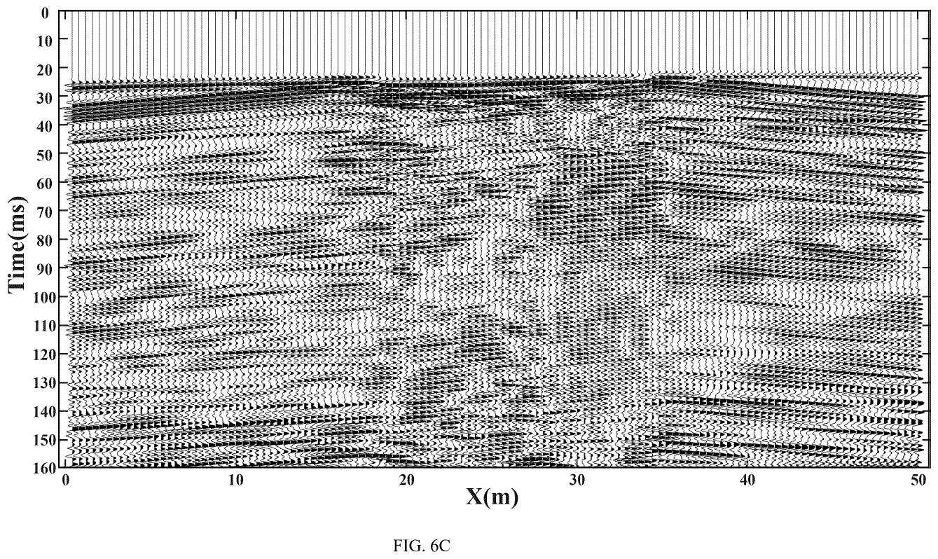

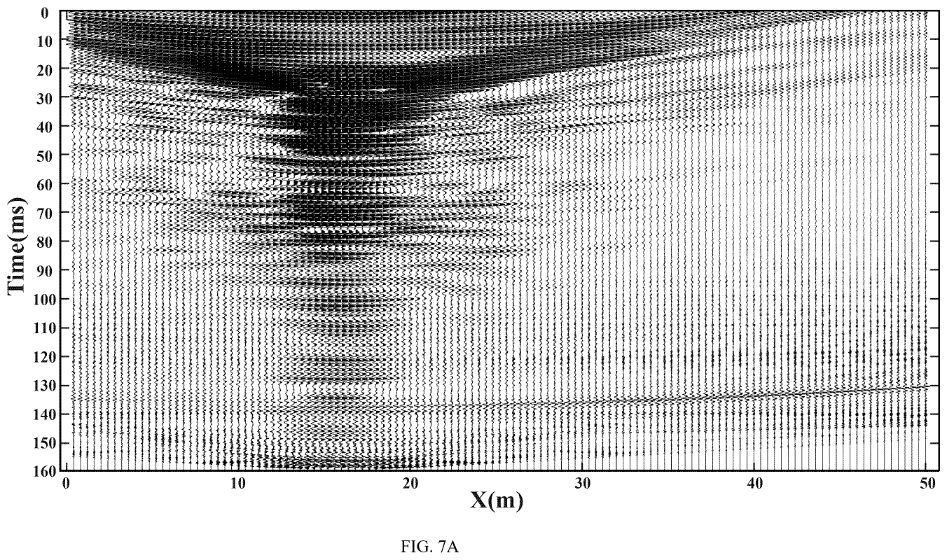

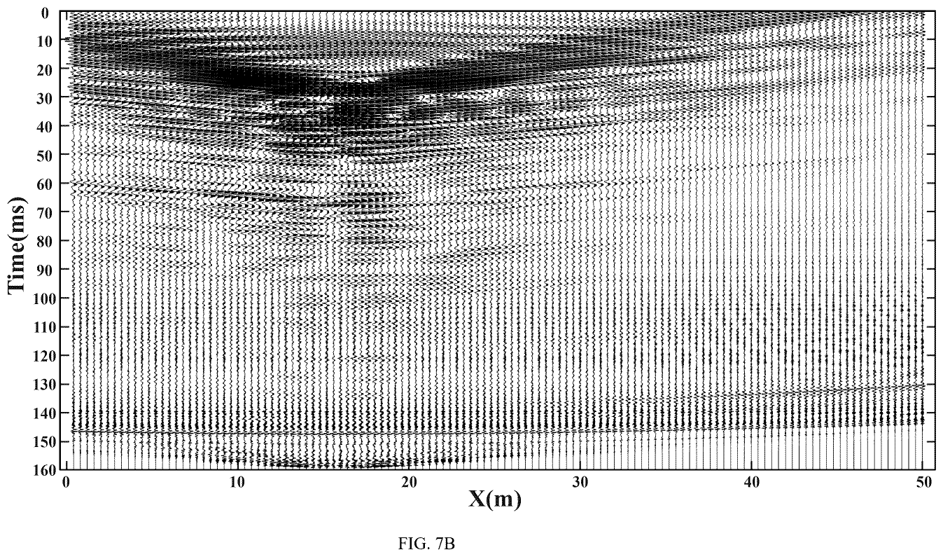

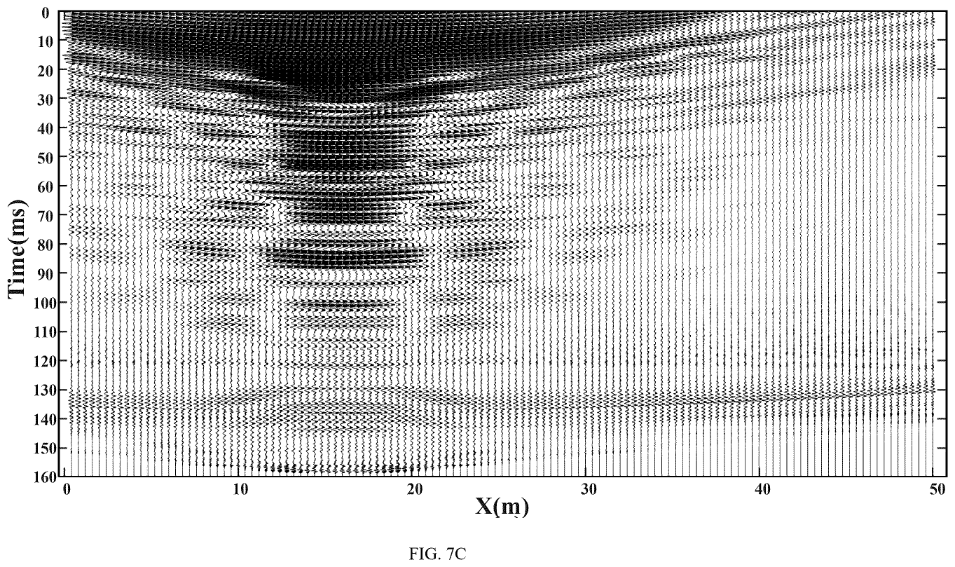

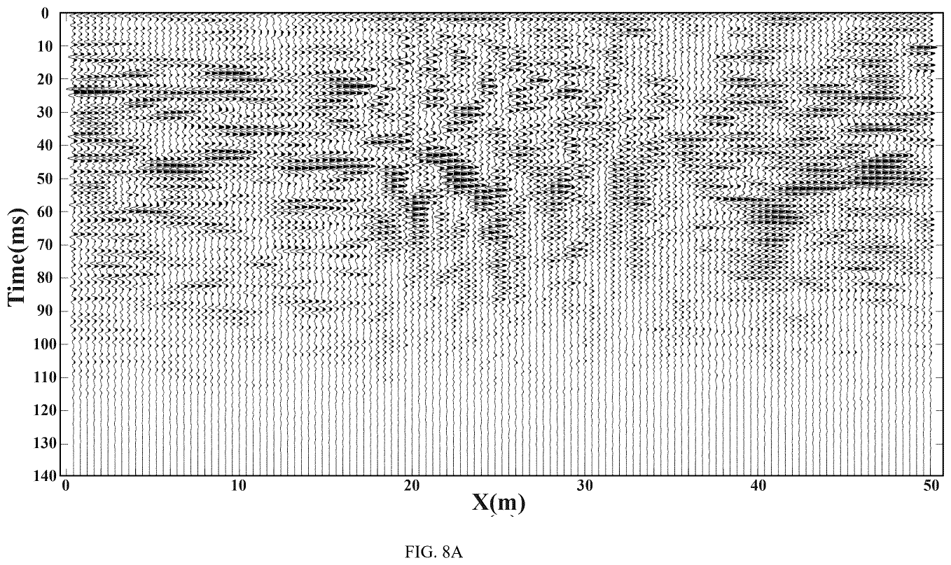

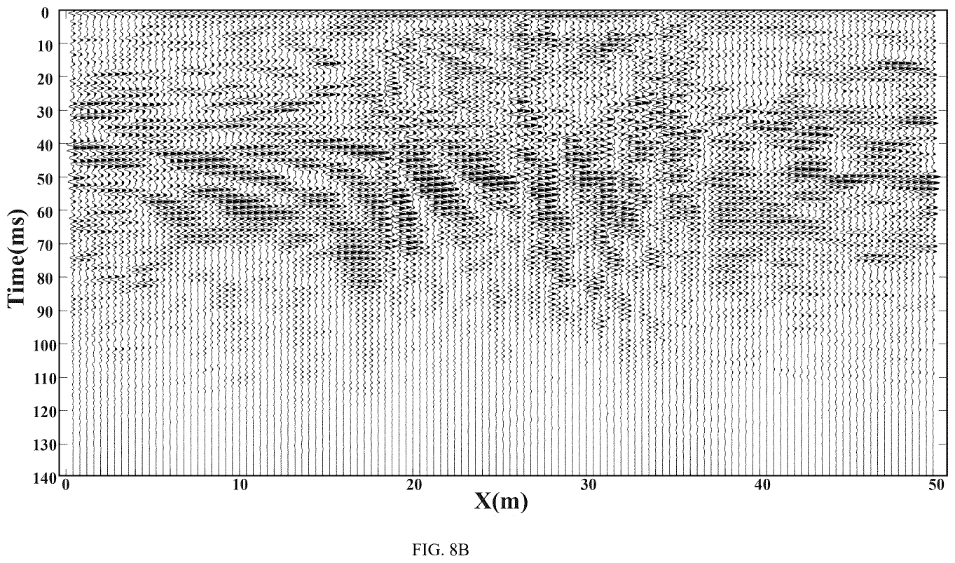

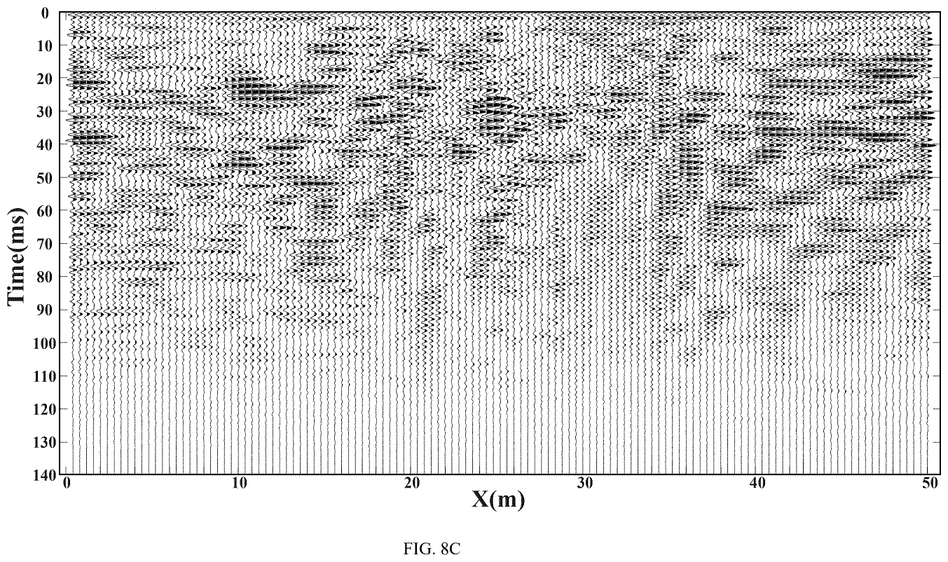

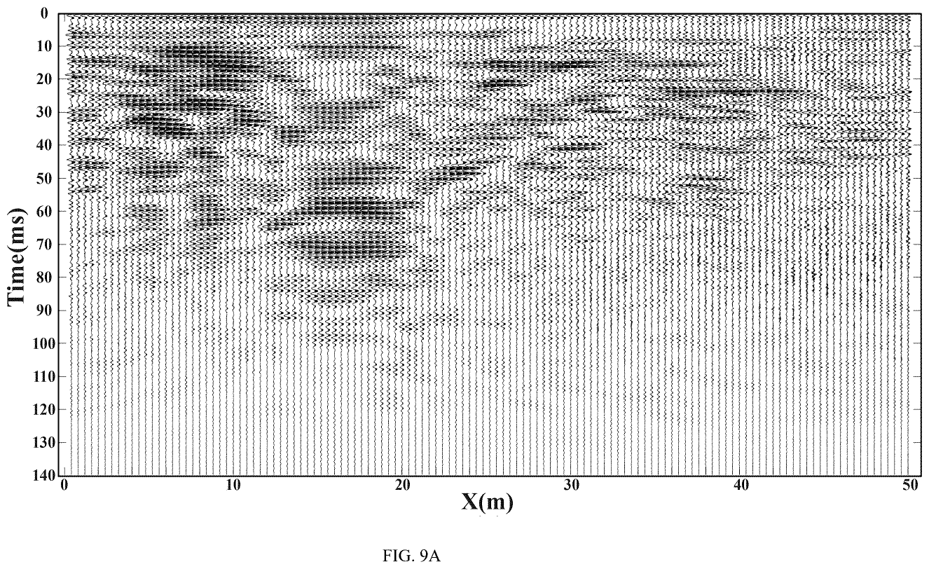

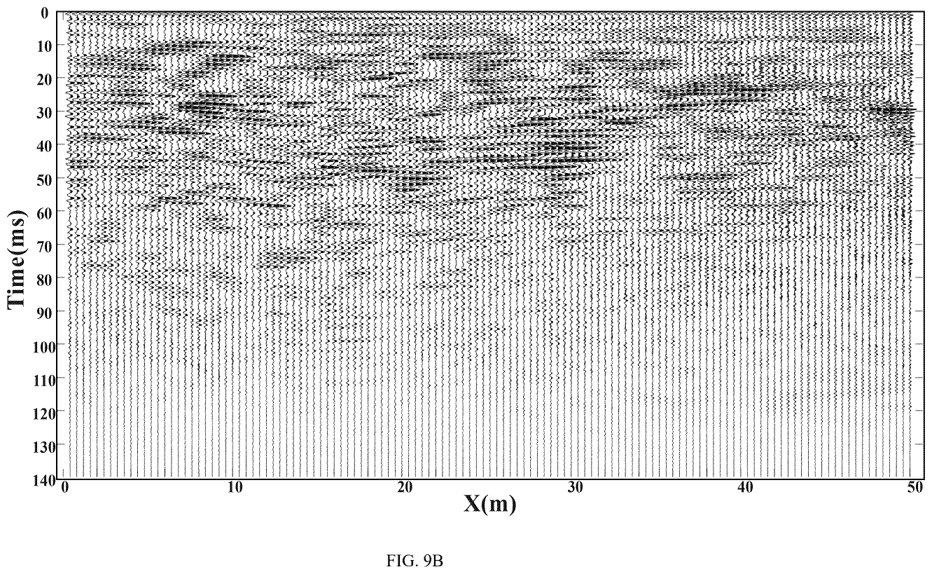

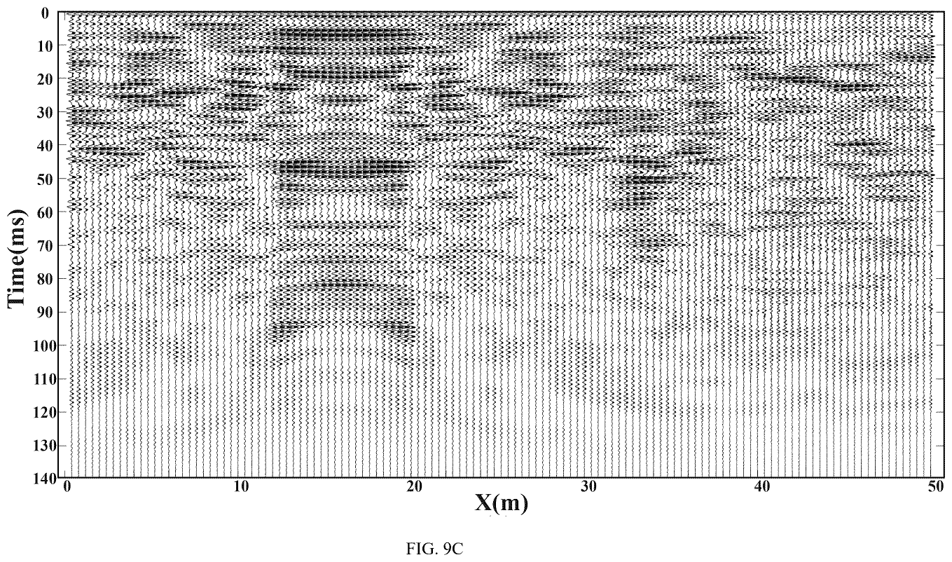

To facilitate comparison with the reverse-time extrapolation results, geophones were also deployed on the tunnel face during the numerical simulation, with heights of the geophones aligned with the shot points and detection positions. The three-component wavefield records received by the geophones at tunnel face are shown in FIGS. 6A-6C. The wavefield records received by geophone G2 at the tunnel wall were restored to the tunnel face location using the three-dimensional reverse-time extrapolation method for seismic waves of the present disclosure, and the results are shown in FIGS. 7A-7C. For comparison, the wavefield records in FIGS. 6 and 7 were subjected to autocorrelation imaging to convert the wavefield records excited by the tunnel wall and received by the tunnel face into wavefield records excited by the tunnel face and received by the tunnel face, and the results are shown in FIGS. 8 and 9, respectively. FIGS. 8 and 9 show clear similarity, especially in the Y-component. Compared with FIGS. 5A-5C, the resolution of reflected wave in FIGS. 9A-9C is significantly improved, and with less surface-wave interference. The numerical stimulation results demonstrate that the resolution of the wavefield records obtained through the three-dimensional reverse-time extrapolation method for seismic waves is close to that of the wavefield records directly recorded on the tunnel face and superior to that of the wavefield records received by the tunnel wall.

The methods of the present disclosure are mainly applied in the field of tunnel seismic advance predication.

Finally, it should be noted that the above description illustrates only specific embodiments of the present disclosure. Those skilled in the art may make various modifications and variations without departing from the scope of the present disclosure. Such modifications and variations that fall within the scope of the appended claims and their equivalents should be regarded as being covered by the scope of protection of the present disclosure.

What is claimed is:

1. A three-dimensional reverse-time extrapolation method for seismic waves, comprising following steps:
step 1: picking first-arrival traveltime information of seismic data excited and received by a tunnel wall, and calculating a P-wave velocity (Vp) and an S-wave velocity (Vs) of a surrounding rock based on a spacing between shot points;
step 2: performing three-dimensional reverse-time extrapolation from maximum time to minimum time by using the resulting P-wave velocity (Vp) and the S-wave velocity (Vs) as a velocity model, and deploying a virtual geophone on a tunnel face during the calculation to receive a wavefield in the three-dimensional reverse-time extrapolation; and
step 3: performing autocorrelation imaging on the wavefield after the three-dimensional reverse-time extrapolation, and further converting a seismic wavefield excited by a tunnel wall and received by the tunnel face into a seismic wavefield excited by the tunnel face and received by the tunnel face.

2. The three-dimensional reverse-time extrapolation method for seismic waves according to claim 1, wherein derivation formulas for the three-dimensional reverse-time extrapolation in the step 2 are as follows:
formulas for calculating decoupled first-order partial differential equations in a three-dimensional elastic wave equation are expressed as follows:
$$\frac{\partial {v}_{x}}{\partial t} = \frac{1}{ρ} ( \frac{\partial {τ}_{xx}}{\partial x} + \frac{\partial {τ}_{xy}}{\partial y} + \frac{\partial {τ}_{xz}}{\partial z} + {f}_{x} ) ; \qquad ( 1 )$$
$$\frac{\partial {v}_{y}}{\partial t} = \frac{1}{ρ} ( \frac{\partial {τ}_{xy}}{\partial x} + \frac{\partial {τ}_{yy}}{\partial y} + \frac{\partial {τ}_{yz}}{\partial z} + {f}_{y} ) ; \qquad ( 2 )$$
$$\frac{\partial {v}_{z}}{\partial t} = \frac{1}{ρ} ( \frac{\partial {τ}_{xz}}{\partial x} + \frac{\partial {τ}_{yz}}{\partial y} + \frac{\partial {τ}_{zz}}{\partial z} + {f}_{z} ) ; \qquad ( 3 )$$
$$\frac{\partial {τ}_{xx}}{\partial t} = ( λ + 2 μ ) \frac{\partial {v}_{x}}{\partial x} λ ( \frac{\partial {v}_{y}}{\partial y} + \frac{\partial {v}_{z}}{\partial z} ) ; \qquad ( 4 )$$
$$\frac{\partial {τ}_{yy}}{\partial t} = ( λ + 2 μ ) \frac{\partial {v}_{y}}{\partial y} λ ( \frac{\partial {v}_{x}}{\partial x} + \frac{\partial {v}_{z}}{\partial z} ) ; \qquad ( 5 )$$
$$\frac{\partial {τ}_{zz}}{\partial t} = ( λ + 2 μ ) \frac{\partial {v}_{z}}{\partial z} λ ( \frac{\partial {v}_{x}}{\partial y} + \frac{\partial {v}_{y}}{\partial x} ) ; \qquad ( 6 )$$
$$\frac{\partial {τ}_{xy}}{\partial t} = μ ( \frac{\partial {v}_{x}}{\partial y} + \frac{\partial {v}_{y}}{\partial x} ) ; \qquad ( 7 )$$
$$\frac{\partial {τ}_{xz}}{\partial t} = μ ( \frac{\partial {v}_{x}}{\partial z} + \frac{\partial {v}_{z}}{\partial x} ) ; \qquad ( 8 )$$
$$\frac{\partial {τ}_{yz}}{\partial t} = μ ( \frac{\partial {v}_{y}}{\partial z} + \frac{\partial {v}_{z}}{\partial y} ) ; \qquad ( 9 )$$
the differential equations (1)-(9) are discretized to obtain finite difference formulas for the three-dimensional time-reverse extrapolation:
$${v}_{x i + 1 / 2 , j , k}^{n - 1 / 2} = {v}_{x i + 1 / 2 , j , k}^{n + 1 / 2} - \frac{Δ t}{Δ x} ( {τ}_{xx i + 1 / 2 , j , k}^{n} - {τ}_{xx i + 1 / 2 , j , k}^{n} ) - \frac{Δ t}{Δ y} ( {τ}_{xy i + 1 / 2 , k}^{n} - {τ}_{xy i , j + 1 / 2 , k}^{n} ) - \frac{Δ t}{Δ z} ( {τ}_{xz i , j , k + 1 / 2}^{n} - {τ}_{xz i , j , k - 1 / 2}^{n} ) + {f}_{x} ; \qquad ( 10 )$$
$${v}_{yi j + 1 / 2 , k}^{n - 1 / 2} = {v}_{yi , j + 1 / 2 , k}^{n + 1 / 2} - \frac{Δ t}{Δ x} ( {τ}_{xy i + 1 / 2 , j , k}^{n} - {τ}_{xy i + 1 / 2 , j , k}^{n} ) - \frac{Δ t}{Δ y} ( {τ}_{yy i , j + 1 / 2 , k}^{n} - {τ}_{yy i , j + 1 / 2 , k}^{n} ) - \frac{Δ t}{Δ z} ( {τ}_{yz i , j , k + 1 / 2}^{n} - {τ}_{yz i , j , k - 1 / 2}^{n} ) + {f}_{y} ; \qquad ( 11 )$$
$${v}_{zi , j , k + 1 / 2}^{n - 1 / 2} = {v}_{zi , j , k + 1 / 2}^{n + 1 / 2} - \frac{Δ t}{Δ x} ( {τ}_{xz i + 1 / 2 , j , k}^{n} - {τ}_{xz i - 1 / 2 , j , k}^{n} ) - \frac{Δ t}{Δ y} ( {τ}_{yz i , j + 1 / 2 , k}^{n} - {τ}_{yz i , j + 1 / 2 , k}^{n} ) - \frac{Δ t}{Δ z} ( {τ}_{zz i , j , k + 1 / 2}^{n} - {τ}_{zz i , j , k - 1 / 2}^{n} ) + {f}_{z} ; \qquad ( 12 )$$
for velocity components:
$${τ}_{xxi , j , k}^{n} = {τ}_{xxi , j , k}^{n + 1} - \frac{Δ t}{Δ x} ( λ + 2 μ ) ( {v}_{x i + 1 / 2 , j , k}^{n + 1 / 2} - {v}_{x i - 1 / 2 , j , k}^{n + 1 / 2} ) - \frac{Δ t}{Δ y} λ ( {v}_{y i , j + 1 / 2 , k}^{n + 1 / 2} - {v}_{y i , j - 1 / 2 , k}^{n + 1 / 2} ) - \frac{Δ t}{Δ y} λ ( {v}_{z i , j , k + 1 / 2}^{n + 1 / 2} - {v}_{z i , j , k - 1 / 2}^{n + 1 / 2} ) ; \qquad ( 13 )$$
$${τ}_{yy i , j , k}^{n} = {τ}_{yy i , j , k}^{n + 1} - \frac{Δ t}{Δ y} ( λ + 2 μ ) ( {v}_{y i , j + 1 / 2 , k}^{n + 1 / 2} - {v}_{y i , j - 1 / 2 , k}^{n + 1 / 2} ) - \frac{Δ t}{Δ x} λ ( {v}_{x i + 1 / 2 , j , k}^{n + 1 / 2} - {v}_{x i - 1 / 2 , j , k}^{n + 1 / 2} ) - \frac{Δ t}{Δ z} λ ( {v}_{z i , j , k + 1 / 2}^{n + 1 / 2} - {v}_{z i , j , k - 1 / 2}^{n + 1 / 2} ) ; \qquad ( 14 )$$
$${τ}_{zz i , j , k}^{n} = {τ}_{zz i , j , k}^{n + 1} - \frac{Δ t}{Δ z} ( λ + 2 μ ) ( {v}_{y i , j + 1 / 2 , k}^{n + 1 / 2} - {v}_{y i , j - 1 / 2 , k}^{n + 1 / 2} ) - \frac{Δ t}{Δ x} λ ( {v}_{x i + 1 / 2 , j , k}^{n + 1 / 2} - {v}_{x i - 1 / 2 , j , k}^{n + 1 / 2} ) - \frac{Δ t}{Δ z} λ ( {v}_{z i , j , k + 1 / 2}^{n + 1 / 2} - {v}_{z i , j , k - 1 / 2}^{n + 1 / 2} ) ; \qquad ( 15 )$$
$$\begin{matrix}{τ}_{xyi + 1 / 2 , j + 1 / 2 , k}^{n} = {τ}_{xyi + 1 / 2 , j + 1 / 2 , k}^{n + 1} - \frac{Δ t}{Δ y} ( {v}_{x i , j + 1 / 2 , k}^{n + 1 / 2} - {v}_{x i , j - 1 / 2 , k}^{n + 1 / 2} ) - \frac{Δ t}{Δ x} ( {v}_{y i + 1 / 2 , j , k}^{n + 1 / 2} - {v}_{y i - 1 / 2 , j , k}^{n + 1 / 2} ) ; & ( 16 )\end{matrix}$$
$${τ}_{xzi + 1 / 2 , j , k + 1 / 2}^{n} = {τ}_{xzi + 1 / 2 , j , k + 1 / 2}^{n + 1} - \frac{Δ t}{Δ z} ( {v}_{x i , j , k + 1 / 2}^{n + 1 / 2} - {v}_{x i , j , k - 1 / 2}^{n + 1 / 2} ) - \frac{Δ t}{Δ x} ( {v}_{z i + 1 / 2 , j , k}^{n + 1 / 2} - {v}_{z i - 1 / 2 , j , k}^{n + 1 / 2} ) ; \qquad ( 17 )$$
$${τ}_{yzi , j + 1 / 2 , j , k + 1 / 2}^{n} = {τ}_{yzi , j + 1 / 2 , k + 1 / 2}^{n + 1} - \frac{Δ t}{Δ z} ( {v}_{y i , j , k + 1 / 2}^{n + 1 / 2} - {v}_{y i , j , k - 1 / 2}^{n + 1 / 2} ) - \frac{Δ t}{Δ y} ( {v}_{z i , j + 1 / 2 , k}^{n + 1 / 2} - {v}_{z i , j - 1 / 2 , k}^{n + 1 / 2} ) ; \qquad ( 18 )$$
in the above formulas, i, j and k are subscripts in X, Y, and Z spatial directions, respectively; n is a superscript of time, Δx, Δy and Δz denote grid spacings in X, Y, and Z directions, respectively, with a sampling interval of Δt, X, Y, and Z denote three directions in a tunnel space, X is a horizontal direction parallel to the tunnel face, Y is a tunnel advancing direction, and Z is a vertically downward direction parallel to the tunnel face; Formulas (1)-(18) are 2-order accurate in both space and time; and similarly, a spatial accuracy can be extended to 2 L-order, and L is an integer ranging from 1 to 6; in Formulas (1)-(18), v_{y}, v_{y} and v_{z} denote velocity components in the X, Y, and Z directions, respectively; (τₓₓ, τ_{yy}, τ_{zz}, τ_{xy}, τ_{yz}, τ_{xz}) denote stress components; τₓₓ denotes a stress component in an X direction, τ_{yz} denotes a stress component in a Y direction, τ_{zz} denotes a stress component in a Z direction, τ_{xy} denotes a stress component of a resultant force in X and Y direction, τ_{yz} denotes a stress component of a resultant force in Y and Z direction, and τ_{xz} denotes a stress component of a resultant force in X and Z direction; (fₓ, f_{y}, f_{z}) denote a body-force source component in the X, Y, and Z directions, and denote three-component seismic data received by the tunnel wall during the three-dimensional reverse-time extrapolation, ρ denotes a density of media; λ and μ denote a first parameter and a second parameter of Lamé constants, respectively, and have relationships with the P-wave velocity (Vp) and the S-wave velocity (Vs) as follows:
$$λ = ρ ( {Vp}^{2} - 2 {Vs}^{2} ) ; \qquad ( 19 )$$
$$μ = ρ {Vs}^{2} ; \qquad ( 20 )$$
a wavefield from maximum time to minimum time is calculated through the reverse-time extrapolation by using the calculation formulas given in Formulas (9)-(18), and the virtual geophone deployed on the tunnel face is configured to receive the wavefield in the reverse-time extrapolation during the calculation.

3. The three-dimensional reverse-time extrapolation method for seismic waves according to claim 1, further comprising a step 4 as follows: performing band-pass filtering, automatic gain control, predictive deconvolution, full-waveform inversion, reverse-time migration data processing based on the results obtained in the step 3.

4. A high-resolution tunnel seismic advance prediction method, comprising the three-dimensional reverse-time extrapolation method according for seismic waves to claim 1, wherein
a virtual geophone is disposed on a tunnel face; an observation system for tunnel wall excitation-tunnel wall reception is calculated by applying three-dimensional reverse-time extrapolation, a wavefield received by a tunnel wall is recursively extrapolated to a location of the virtual geophone on the tunnel face, and an observation system for tunnel wall excitation-tunnel wall reception is finally converted; wherein
steps for data processing are as follows:
step A: data preprocessing, comprising data editing, band-pass filtering, F-K filtering and automatic gain control;
step B: data imaging, comprising three-dimensional reverse-time extrapolation, predictive deconvolution, full-waveform inversion and two-dimensional/three-dimensional migration imaging; wherein the three-dimensional reverse-time extrapolation adopts the three-dimensional reverse-time extrapolation method for seismic waves to process the data; and
step C: geological interpretation: extracting unfavorable geological bodies, determining surrounding-rock classification, and providing support recommendations based on results of the full-waveform inversion and reverse-time migration imaging.
